(19) United States
(12) Patent Application Publication
(10) Pub. No.: US 2006/0087851 A1
(43) Pub. Date: Apr. 27, 2006

(54) Encasing for light circuit

(76) Inventor: Jack G. Dubord, Escondido, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/249,785

(22) Filed: Oct. 12, 2005

Related U.S. Application Data
(60) Provisional application No. 60/618,328, filed on Oct. 13, 2004.

(51) Int. Cl. F21V 15/00

(52) U.S. Cl. 362/362

(57) ABSTRACT

An illumination device comprising a protective encasing for LED components and associated circuitry. The encasing is sealed to protect the encased components from external elements and prevent corrosion. The encasing includes a top half and a bottom half, which is configured to mate with the top half and provide an internal chamber for the LED components and circuitry. The encasing also includes at least one translucent and interchangeable cap that is configured to mate with a flange on the top half of the encasing so as to enclose the LED components and circuitry. The interchangeable cap is available in different colors so that different colored light may be emitted from the illumination device. An alternative embodiment of the illumination device includes a gasket positioned between the top and bottom halves of the encasing to better seal the two halves. Additionally, a gasket, or O-ring can be positioned between the cap and flange to better seal the cap to the top half of the encasing. Alternatively, or additionally, a gel core may be used within the encasing and/or within the cap and flange to seal and insulate the LED lights.

### CROSS-REFERENCE TO RELATED APPLICATIONS

This application claims benefit of U.S. provisional application 60/618,328 filed Oct. 13, 2004. The contents of this document are incorporated herein by reference.

### BACKGROUND OF THE INVENTION

1. Field of the Invention

Generally, the invention relates to lighting devices. More particularly, the invention relates to a protective encasing for light emitting diode (LED) circuits.

2. Description of the Related Art

Light emitting diodes (LED's) are well known as a low cost, energy efficient light source. One application for LED's is to illuminate translucent signs such as channel letter signs as described in, for example, U.S. Pat. No. 6,558,021 to Wu et al. Conventional LED devices, however, have not provided a LED device package wherein the color of the LED's can be easily changed in accordance with a user's tastes. Additionally, conventional LED devices do not provide a weather-proof and/or water-proof or water-resistant encasing that protects the encased LED circuitry from external, potentially-damaging elements such as moisture, dust and other debris.

### SUMMARY OF THE INVENTION

The invention addresses the deficiencies of prior modular light devices by providing a protective encasing for light emitting components and associated circuitry.

In one embodiment, a protective casing includes one or more interchangeable colored or clear protective caps, which allow the color of light passing through the caps to be changed by a user in accordance with his or her preferences.

In a further embodiment, the encasing is weather-proof to protect the encased circuitry from external elements (e.g., moisture, debris, dust, rust, etc.) and prevent corrosion or other types of damage to the circuitry. In a further embodiment, the encasing is water-proof such that it prevents moisture from contacting the encased components.

In one embodiment, the encasing includes a bottom half (preferably injection molded) and a top half (also preferably injection molded), which is configured to mate with the bottom half and provide an internal chamber for at least one LED and its associated circuitry. The top half includes at least one opening defined by a lip or flange that extends outwardly from a top surface of the top half. The opening allows light from the at least one LED to shine outwardly from the encasing. The encasing further includes at least one translucent and interchangeable cap that is configured to mate with the lip or flange so that it becomes fixed with the top half of the encasing, thereby enclosing the LED and its associated circuitry within the encasing. The interchangeable cap is available in different colors so that a user can select a desired color of light that shines through the cap. In a further embodiment, the colors of the LED's may also be changed (e.g., at the manufacturing stage or by an end user) so that different combinations of LED colors and cap colors may be selected to achieve a customized illumination color.

In a further embodiment, the encasing further includes a gasket configured to be positioned between the bottom and top halves of the encasing, thereby providing a weather-proof and/or water-proof seal where the bottom half joins with the top half of the casing. Additionally, in a further embodiment, the encasing further includes a second gasket or O-ring configured to be positioned between the cap and the flange such that a weather-proof and/or water-proof seal is provided at an intersection where the cap meets the flange of the top half.

### BRIEF DESCRIPTION OF THE DRAWINGS

FIG. 1 provides an exploded, perspective view of the various components of an encased LED device in accordance with one embodiment of the invention.

FIG. 2 provides an exploded side view of the various components of the encased LED device of FIG. 1.

FIG. 3A illustrates a top view of a PC board having two LED's thru-hole mounted thereon, in accordance with one embodiment of the invention.

FIG. 3B illustrates a bottom view of the PC board of FIG. 3A with other LED circuitry components surface mounted to the bottom of the board, in accordance with one embodiment of the invention.

FIG. 3C illustrates a circuit schematic diagram of a conventional LED circuit with driver circuitry.

FIG. 4A illustrates a top view of a PC board having LED and associated driver circuit components surface mounted to the top surface of the PC board, in accordance with one embodiment of the invention.

FIG. 4B illustrates a bottom view of the PC board of FIG. 3A with a metal surface layer for providing cooling to the LED components surface mounted on the top surface of the PC board, in accordance with one embodiment of the invention.

FIG. 4C illustrates a circuit schematic diagram of another conventional LED circuit with driver circuitry.

FIG. 5 illustrates a plurality of LED units wired in series, in accordance with one embodiment of the invention.

FIGS. 6A and 6B illustrate perspective views of a light fixture made from a plurality of LED units, in accordance with one embodiment of the invention.

### DETAILED DESCRIPTION OF THE PREFERRED EMBODIMENT

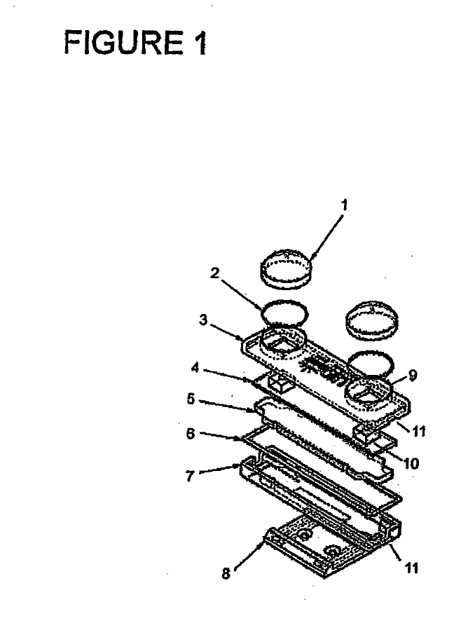

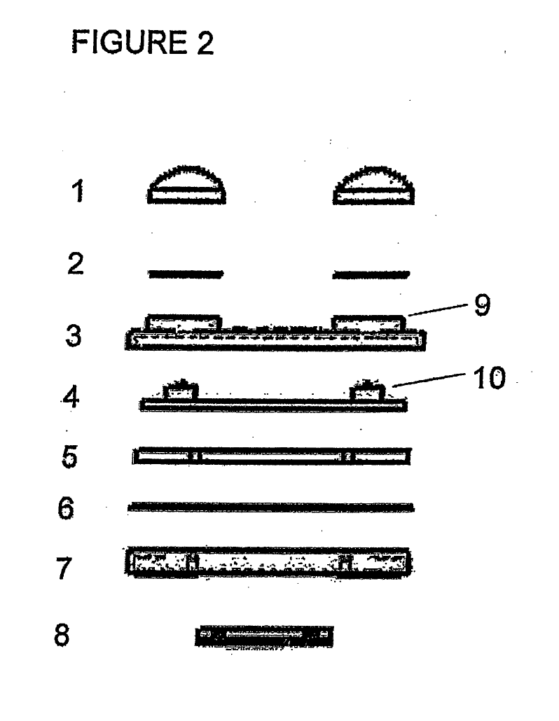

The invention is now described in detail with reference to the figures. In one embodiment, the invention provides a self-contained protective encasing (preferable injection molded) for light emitting diode (LED) circuits, which is weatherproof and/or waterproof and further provides one or more interchangeable colored or clear protective caps allowing the color of light emitted by the device to be customized in accordance with a user's preferences. In one embodiment, the encased LED device includes eight parts as illustrated in FIGS. 1 and 2. These parts are not limited in shape or material.

Referring to FIG. 1, clear or colored caps 1 are designed to fit over the collar or flange 9 which extends outwardly from a top surface of a top half 3 of an encasing. In one embodiment the caps 1 are dome shaped, as illustrated in FIG. 1, and designed with a curved contour shape for better protection on impact. The caps 1 may be connected with the collar or flange 9 by various known methods, including external or internal threads (not shown) that mate with corresponding internal or external threads (not shown) located on the flange 9, compression fitting, snap fitting, magnetic connection, velcro, and/or O-ring seals. The caps 1 can be made of any material such as, but not limited to, plastic, gel, glass, cellophane, or fabric screening. In one embodiment, the purpose of the caps is to create individual interchangeable customized color as well as to protect, weatherproof and/or waterproof the product. In one embodiment, the caps 1 are not permanently attached to the flange 9 and are interchangeable with other caps 1 of various colors to create a desired illumination color. Additionally, the color of the underlying LED's may also be selected (either during manufacturing or changed by an end user) so that various combinations of LED colors and cap colors may be “mixed” to create a custom color desired by the end user. For example, a red colored LED with a blue colored plastic cap creates a purple light. In a further embodiment, the cap 1 can provide protection against ultra-violet (UV) radiation that may otherwise damage underlying components and/or materials.

O-rings 2 are configured to be placed between the cap 1 and the flange 9 to provide a weather-proof and/or water-proof seal. The O-Ring 2 is configured in a corresponding shape of the flange 9 and the cap 1 and can vary as the size, shape and mating configurations of the flange 9 and cap 1 varies. Additionally, the O-ring 2 can be made from any one or combination of a variety of materials such as rubber, plastic, gel, etc.

The top half 3 of the encasing includes the collar or flange 9 which extends outwardly from a top surface of the top half 3. The collar or flange 9 defines an opening in the encasing through which light from a LED 10 can exit the encasing. In one embodiment, the flange 9 is wider on the bottom close to the plate and minutely larger at the bottom than the internal diameter of the base of the clear or colorized caps 1, such that the caps 1 will achieve a compression fit over the collar or flange 9. Additionally, the collar or flange 9 surrounds the LED 10, providing extra protection for the LED 10.

The top half 3 of the encasing in combination with a bottom half 1 of the encasing and the caps 1 enclose a LED printed circuit (PC) board 4 and associated LED's 10, providing protection from dust, impact, weather, and water (if used with gaskets and O-rings). In preferred embodiments, these pieces are made from rigid injection molded material(s).

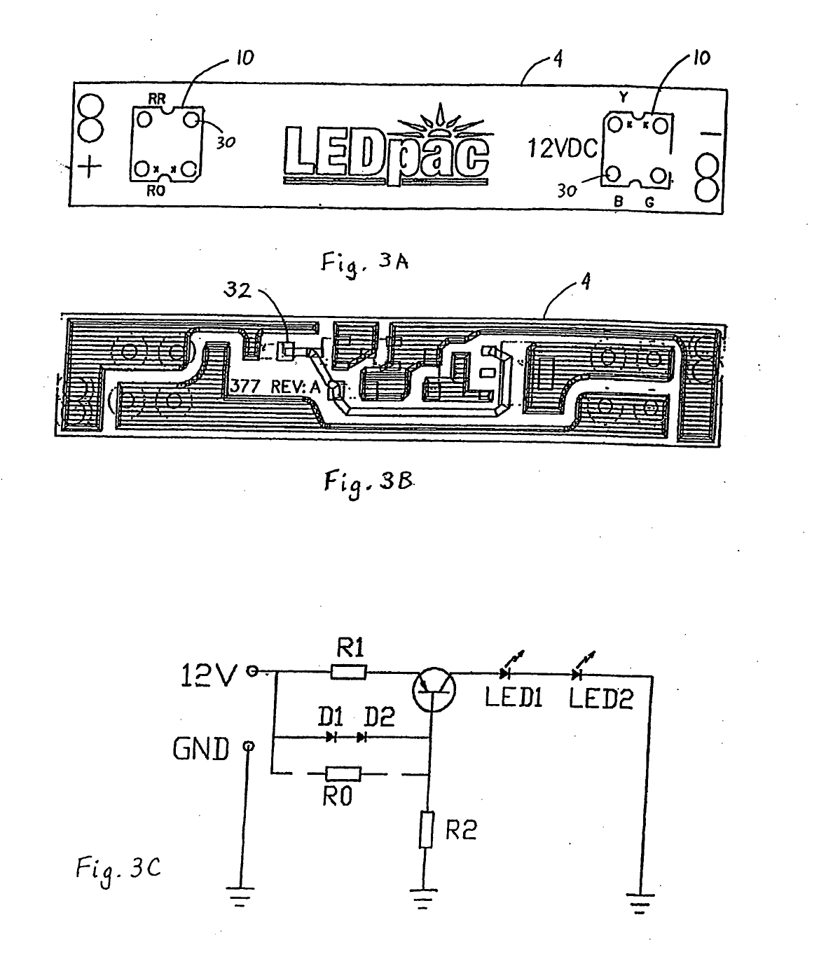

The PC board 4 fits within an internal chamber between the top and bottom halves 3 and 7, respectively, of the encasing. In one embodiment, the PC board is uniquely engineered to enhance brightness and minimize dimming. Referring to FIGS. 3A and 3B, the top and bottom of a PC board 4 is shown in accordance with one embodiment of the invention. As shown in FIG. 3A, two LED's 10 are mounted with thru-hole pins 30 that extend to the bottom surface of the PC board 4 and make electrical contact with appropriate contact traces. On the bottom surface of the PC board 4 (FIG. 3B), the remaining components of the LED circuit are surface mounted such that appropriate contacts are made with conduction pads and traces to form the circuit illustrated in the schematic diagram of FIG. 3C. In one embodiment, when the PC board 4 is placed into the bottom half of the encasing 7, a gel substance or gel core 5 is placed or poured into the bottom half of the encasing 7 to surround and encase the components inside the receptacle 7 and allowed to cure. The gel core 5 thereby performs the function of protecting the electronic components from impact, as well as weather-proofing and/or water-proofing the components. In one embodiment, discrete components and one or more LED's 10 can be placed inside the encasing formed by halves 3 and 7 and wired together without a PC board 4. The gel core 5 is then injected or inserted into the cavity of the encasing in order to surround, support and protect the components and LED 10, which are not otherwise fixed in place with respect to one another. In one embodiment, the gel core 5 further serves as a heat reservoir for absorbing or diverting heat away from the components and LED 10 during operation.

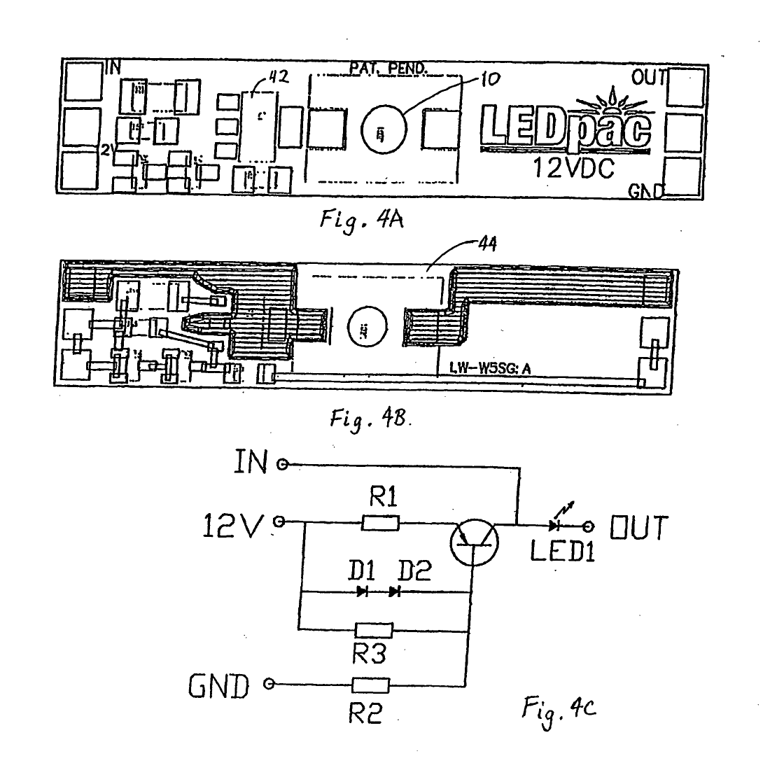

It is appreciated that the PC board 4 can be designed to support any number or combination of LED's. In one embodiment, as shown in FIG. 4A, the board 4 is configured to support a single LED 10 which is surface mounted to the top of the PC board 4. Also surface mounted on the top surface of the PC board 4 are additional components 42 that create the LED circuit as shown in the circuit diagram of FIG. 4C. FIG. 4B illustrates a bottom surface of the PC board 4 having a metal base layer 44 covering at least a portion of the bottom surface area of the PC board 4, in accordance with one embodiment of the invention. The metal base layer 44 serves as a heat reservoir or cooling element for the LED 10 and/or other components 42 that are mounted on the top surface of the board 4. Appropriate contacts are made between the metal base layer 44 and the LED 10 and/or other components 42 so as to absorb and dissipate heat away from the LED 10 and/or other components 42. The metal base layer 44 may be made from any suitable metal or metal alloy such as aluminum, gold, tin, etc.

In one embodiment, a gel core 5 made of a mixture of silicone and a metal (e.g., Aluminum) powder is injected into the bottom half of the encasing in order to surround, cover or encase the bottom half of the PC board 4 and the metal base layer 44. The gel core 5 not only provides protection and insulation for the board 4 but provides an additional heat reservoir that augments the metal base layer's heat reservoir functionality, allowing for better absorption and dissipation of heat from the board 4. Consequently, the LED circuitry can operate at higher temperatures, which means the light intensity can be greater providing for a brighter light source.

In one embodiment, discrete circuit components 32, 42 provide for a relatively consistent current intensity to the LED 10 and absorb variations in the input voltage supply, thereby allowing the use of 9 v or 12 v DC or solar power supplies with minimal dimming. Additionally, as shown in FIGS. 3C and 4C, the LED circuitry includes blocking diodes (D1, D2) that protect the circuit from cross-wiring (i.e., damage from inversion of polarity between the power supply and ground).

In one embodiment, the gel core 5 provides insulation to protect, weatherproof and/or waterproof LED's and electronics within the encasing. The gel can be made of such materials as silicone, resins, tar, pharmaceutical high heat solutions, ceramics and other known suitable materials. In one embodiment, the gel core 5 is made from a mixture of silicone and a metal (e.g., Aluminum) powder to assist with heat absorption and dissipation. The gel core 5 is injected or applied into the interior cavity of the encasing formed by the two halves 3 and 7 when they are brought together. The gel core 5 conforms to fit the shape of the interior cavity of the encasing 3, 7 and surrounds at least a bottom half of the PC board 4. In a further embodiment, the gel core 5 can surround and protect the entire PC board 4.

It is appreciated that the “gel core” is not limited to particular materials, chemical compounds or compositions but may be made from any suitable material or composition that provides the protection, insulation and optional heat sinking properties described herein. For example, suitable polymers, resins, silicones, and/or other materials or compositions of synthetic materials may be suitable for use as the gel core 5. Additionally, in one embodiment, the gel core 5 may be optically clear or translucent and fill the entire internal cavity of the encasing as well as the concave cavity formed by the flange 9 so as to completely cover an underlying LED. In this embodiment, it is optional to place a cap 1 over the flange 9. Additionally, the gel core 5 may be tinted or colored so that instead of translucently colored or frosted caps, color is integrated into the optically clear solution or gel 5, which, when cured, adds a desired color to the LED light and protects and water-proofs the LED and any circuitry contained in the encasing.

A gasket 6 is configured to be positioned and fit between the top and bottom halves 3 and 7, respectively, of the encasing. The gasket 6 fits over or around the PC Board 4 and seats over or around a peripheral edge of the bottom half encasing 7. When the top half encasing 3 is placed together with the bottom half encasing 7, the gasket 6 provides a seal between the two halves 3 and 7. In this way, the gasket 6 helps protect, insulate and weatherproof /waterproof the unit.

The bottom half encasing 7 is designed to be a receptacle for the PC board 4 and gels 5. It is unique in that it is substantially weather-proof and sealed, with no breaks, gaps or holes after the two halves 3, 7 of the encasing are brought together. The top half 3 and bottom half 7, in one embodiment, is injection molded, and can be made from any suitable material into any desired size and shape. When using gel core 5 the electronics are insulated for better illumination and LED life. The gasket 6 can fit onto, over or around the bottom half 7 to provide a seal between the top half 3 and the bottom half 7 when the two halves are brought together.

As shown in FIG. 1, indentations 11 formed in the shape of a semi-circle, for example, are provided at each end of each half 3, 7 of the encasing. When the two halves 3 and 7 are brought together and sealed, these indentations 11 provide an opening so that wires can emerge from the encasing by means of openings at the end of the encasing. In one embodiment, the size of the opening formed by the indentations 11 are configured such that they slightly compress the shielding of respective wires that pass through the opening. In this way, the wires (not shown) occupy the entire space of the openings and seal the internal chamber of the encasing occupied by the PC board 4. In a further embodiment, the gel core 5 provides additional insulation and protection for the PC board 4 and seals any possible gaps between the wires and the opening formed by the indentations 11. In a further embodiment, a mounting block 8 provides a cradle, which holds the encased LED device allowing the device to be flexible in the way it is attached to external structures (e.g., a surface of a channel letter sign). The bottom half encasing 7 can be attached to the mounting plate 8 with glue, snaps, compression fitting, tie wire or twist ties wrapped around the two halves 3 and 7, magnets, or Velcro. The purpose of the mounting block 8 is to provide various mounting and installation options. The mounting block 8 enables the user to mount the device to any surface temporarily or permanently using screws, double stick tape, zip ties, twist ties, snaps, rivets, glue, Velcro or any other hardware. In one embodiment, the mounting block 8 is an injection molded piece with areas for ties or wires and providing a bolting plate. This piece can be expanded or altered in the future to accommodate any number of attachment methods.

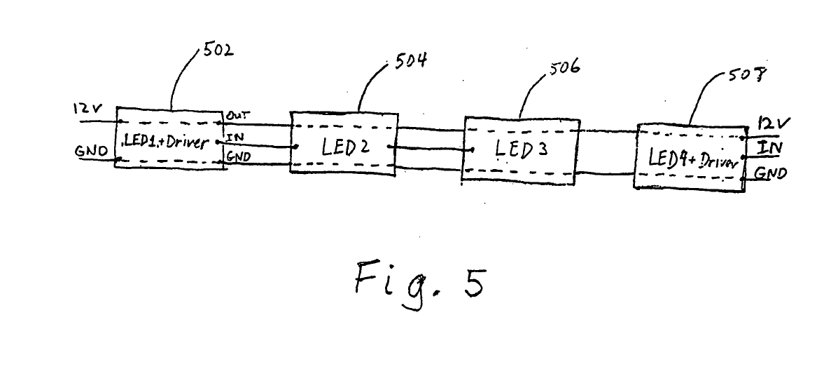

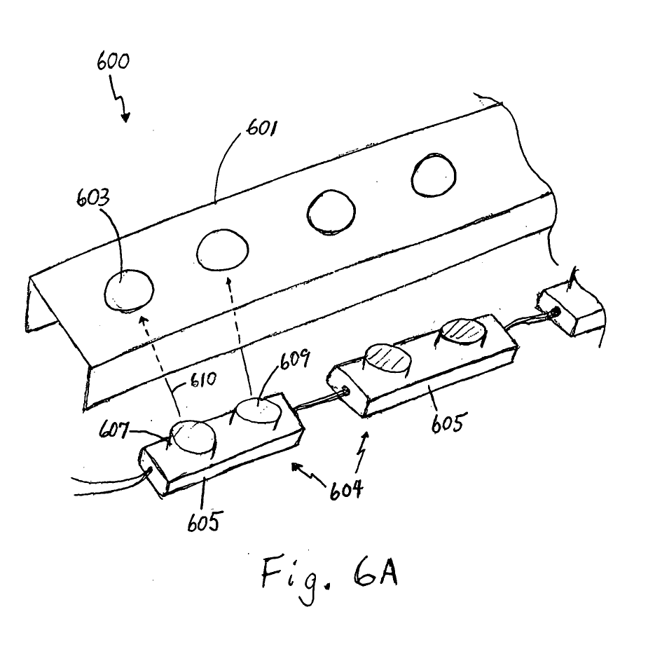

FIG. 5 illustrates an exemplary wiring diagram for a plurality of LED encased units wired together in series. A first LED unit 502 includes driver circuitry for converting a 12 volt D.C. input into an appropriate voltage level (e.g., 3 or 5 volts) for powering the LED 10 of the unit 502. Such driver circuits are well known in the art. An exemplary driver circuit is shown by transistor 46 and resistors R1, R2 and R3 in the circuit schematic diagram of FIG. 4C. In one embodiment, in order to reduce costs in manufacturing PC boards 4 with their associated components, multiple LED units 502, 504 and 506 can be connected in series with only the first LED unit 502 requiring the driver circuitry. Thus, the second and third LED units 504 and 506 can omit the driver circuitry and just include the LED's 10 which are connected to the “IN” lead 48 of the circuit of FIG. 4C. This substantially reduces the cost of the PC board manufacturing and assembly for LED units 504 and 506.

As shown in FIG. 5, the power supply (12 V) and ground lines are continuously run throughout the LED units 502-508 so that the fourth LED unit 508, which also includes a driver circuit, can make appropriate contacts with these lines. It is appreciated, however, that the second and third LED units 504 and 506 need not make an electrical contact with the power supply (e.g., 12 V) and ground lines but is powered by the down-converted voltage (e.g., 5 V) provided by the “IN” line 48. Thus, a plurality of LED units may be illuminated using a single driver circuit resulting in substantial savings in PC board manufacturing and assembly costs. Another significant advantage of the above-described wiring scheme is that it provides superior cooling over a PCB board incorporating a plurality of LED's on a single board. Thus, the wiring scheme discussed above is very well suited for use with bright white or any other high output LED's, which generate a lot of heat. The LED circuitry within the encasing can be powered by, for example, a 9 volt D.C., 12 volt D.C., a solar panel for providing D.C. power, or a 120 volt power pack that supplies a necessary voltage and wattage as needed.

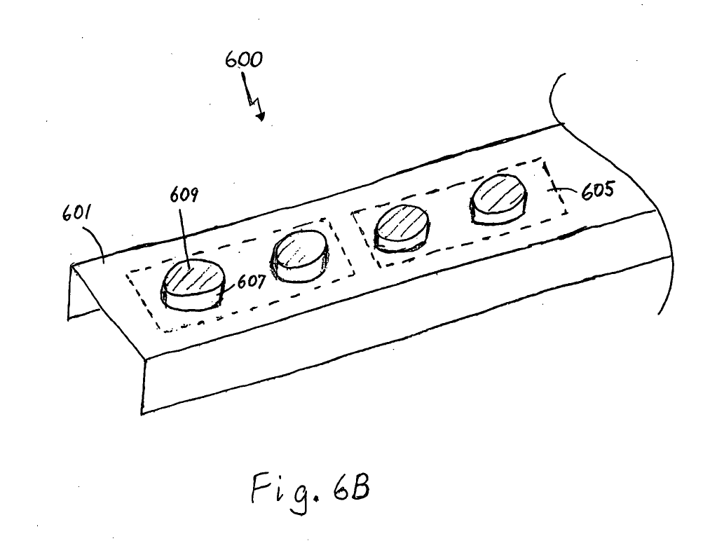

FIG. 6A illustrates a perspective view of an exemplary light fixture 600 that includes a frame or housing 601 having a plurality of holes 603 therein. The housing 601 is configured to hold or be coupled to a plurality of LED illumination devices 604 so as to provide an attractive light fixture for use in a home or office, for example. Each LED illumination device includes an encasing 605 that holds one or more LED lights (not shown) and associated circuitry (e.g., a printed circuit board) therein. Each encasing 605 further includes one or more collars or flanges 607 that define an opening through which LED lights may shine. Each encasing 605 further includes one or more caps 609 configured to be coupled to corresponding flanges 607 so as to seal the LED lights and associated circuitry inside the encasing 605. In one embodiment, the encasings 605 are similar in design and structure to that illustrated and described with respect to FIGS. 1 and 2 above.

As indicated by arrows 610, each cap 609 and corresponding flange 607 is configured to mate with corresponding holes 603 of the housing 601 when the LED devices 604 are attached to a rear surface of the housing 601. FIG. 6B illustrates a perspective view of the LED light fixture 600 when the plurality of LED illumination devices 604 are attached to a rear surface of the housing 601 such that the caps 609 and at least a portion of the corresponding flanges 607 pass through corresponding holes 603 of the housing 601. The encasing 605 (indicated by dashed lines) behind the front surface of the housing 601 may be affixed to the rear surface of the housing 601 using any known means (e.g., glue, adhesive, snap-fit, fasteners, screws, etc.). The shape, style and design of housing 601 is exemplary only. As would be appreciated by those of ordinary skill in the art, the housing 601 many incorporate various shapes, designs and styles to provide a variety of different types of architectural lighting fixtures, in accordance with the present invention.

In preferred embodiments, the caps 609 are interchangeably coupled to the flanges 607 so as to allow for interchangeable colors and shapes of the caps 609. As illustrated in FIGS. 6A and 6B, the caps 609 may have a flat-top surface. Alternatively, they may be dome-shaped or have other desired shapes and/or designs.

Various preferred embodiments of the invention have been described above. However, it is understood that these various embodiments are exemplary only and should not limit the scope of the invention. Various modifications of the preferred embodiments described above can be implemented by those of ordinary skill in the art, without undue experimentation. These various modifications are contemplated to be within the spirit and scope of the invention.

What is claimed is:

1. An illumination device comprising:
an encasing comprising a top half and a bottom half;
said top half of the encasing including at least one opening defined by a flange that extends upwardly from a top surface of said top half of the encasing;
at least one cap configured to be interchangeably coupled to said flange and enclose the top half of said at least one opening;
one or more LED lights configured to be positioned within the encasing such that light from said one or more LED lights may exit the encasing through said at least one opening; and
wherein said bottom half of the encasing is configured to mate with said top half of the encasing to provide a sealed enclosure for said one or more LED lights.

2. The illumination device of claim 1 further comprising a first gasket configured to be placed between said top half and said bottom half of the encasing so as to provide a seal when said top half and said bottom half of the encasing are joined.

3. The illumination device of claim 2 further comprising a second gasket configured to be placed between said at least one cap and said flange, wherein the first and second gaskets facilitate providing a water-resistant enclosure for said one or more LED lights.

4. The illumination device of claim 1 further comprising:
at least one top indentation positioned at one end of said top half of the encasing;
at least one bottom indentation positioned at one end of said bottom half of the encasing; and
wherein said top indentation and bottom indentation form an opening configured to achieve a compression fit with the shielding of one or more wires that pass through said opening and seal said internal chamber when said top half and bottom half of the encasing are joined.

5. The illumination device of claim 1 wherein said at least one cap is generally dome-shaped.

6. The illumination device of claim 1 wherein said at least one cap is made of a material selected from the group consisting of plastic, gel, glass, cellophane, or fabric screening.

7. The illumination device of claim 1 wherein said at least one cap is interchangeable to provide a variety of different translucent colors.

8. The illumination device of claim 1 wherein said at least one cap is configured to achieve a compression fit over said flange.

9. The illumination device of claim 1 further comprising a gasket positioned between said at least one cap and said flange.

10. The illumination device of claim 1 further comprising a gel core inserted into said encasing so as to surround at least a portion of circuitry associated with the one or more LED lights.

11. The illumination device of claim 1 wherein said one or more LED lights are connected to a printed circuit board.

12. The illumination device of claim 11 further comprising a gel core inserted into said encasing so as to surround at least a portion of said printed circuit board.

13. The illumination device of claim 12 wherein said gel core is comprised of silicone and at least one metal power and is injected into said bottom half of the encasing.

14. A housing for one or more LED lights, comprising:
a top half of said housing including at least one opening defined by a flange that extend upwardly from a top surface of said top half, wherein said at least one opening is configured such that light may exit the housing through said at least one opening;
at least one cap configured to be interchangeably coupled to said flange so as to enclose the top half of said at least one opening; and
a bottom half of said housing configured to mate with said top half of the encasing and provide an internal chamber capable of enclosing one or more LED lights, wherein said top half, said bottom half, and said at least one cap provide a sealed enclosure for said one or more LED lights.

15. The housing of claim 14 wherein said at least one cap is generally dome-shaped.

16. The housing of claim 14 wherein said at least one cap is translucent and colored.

17. The housing of claim 14 wherein said at least one cap is configured to achieve a compression fit over said flange.

18. An LED light strip comprising a plurality of electrically connected LED illumination devices, wherein each LED illumination device comprises:
an encasing configured to provide a sealed enclosure for one or more LED lights therein, the encasing providing at least one opening such that light from said one or more LED lights may exit the encasing through said at least one opening; and
wherein said plurality of LED illumination devices are connected in series and powered by a single driver circuit.

19. The LED light strip of claim 18 wherein the encasing comprises:
a top half and a bottom half;
said top half of the encasing including the at least one opening defined by a flange that extends upwardly from a top surface of said top half of the encasing;
at least one cap configured to be coupled to said flange so as to enclose the top half of said at least one opening; and
said bottom half of the encasing is configured to mate with said top half of the encasing to provide a sealed enclosure for said one or more LED lights.

20. The LED light strip of claim 18 wherein said at least one cap is interchangeable to provide a variety of different translucent colors.

21. A LED light fixture, comprising:
a housing configured to hold one or more LED illumination devices, the housing including at least one hole through which LED illumination may shine, and wherein each LED illumination device comprises:
an encasing configured to provide a sealed enclosure for one or more LED lights therein, the encasing including at least one opening defined by a flange that extends upwardly from a top surface of the encasing;
at least one cap configured to be coupled to said flange and enclose the top half of said at least one opening, wherein the one or more LED lights are positioned within the encasing such that light from said one or more LED lights may exit the encasing through said at least one opening; and
wherein the encasing is coupled to the housing such that at least a portion of the flange and the at least one cap passes through the at least one hole so as to permit LED light to pass through the at least one hole.

22. The LED light fixture of claim 21 wherein said plurality of LED illumination devices are connected in series and powered by a single driver circuit.

23. The LED light fixture of claim 22 wherein said at least one cap is generally dome-shaped.

24. The LED light fixture of claim 22 wherein said at least one cap is interchangeable to provide a variety of different translucent colors.

25. The LED light fixture of claim 22 wherein said at least one cap is configured to achieve a compression fit over said flange.

26. The LED light fixture of claim 22 further comprising a gasket positioned between said at least one cap and said flange.

27. The illumination device of claim 22 further comprising a gel core inserted into said encasing so as to surround at least a portion of circuitry associated with the one or more LED lights.

28. A housing for one or more LED lights, comprising:
a top half of said housing including at least one opening defined by a flange that extend upwardly from a top surface of said top half, wherein said at least one opening is configured such that light from one or more LED lights may exit the housing through said at least one opening;
a bottom half of said housing configured to mate with said top half of the encasing and provide an internal chamber for holding the one or more LED lights; and
a translucent material filling the opening defined by the flange so as to cover and protect the one or more LED lights, wherein the top half, the bottom half, and the translucent material provide a sealed enclosure for said one or more LED lights.

29. The housing of claim 28 further comprising a translucent cap configured to be coupled to the flange.

30. The housing of claim 28 wherein said translucent material is a colored translucent material.

31. The housing of claim 28 wherein said translucent material further fills at least a portion of the internal chamber.

32. The housing of claim 28 wherein said translucent material further fills the entirety of the internal chamber and covers the one or more LED lights and associated circuitry.
